(19) United States
(12) Patent Application Publication
(10) Pub. No.: US 2020/0042950 A1
(43) Pub. Date: Feb. 6, 2020

(54) WORKPLACE ACTIVITY TRACKING AND LOCATOR METHOD AND SYSTEM

(71) Applicant: Brady J. Gulden, New Ulm, MN (US)

(72) Inventor: Brady J. Gulden, New Ulm, MN (US)

(21) Appl. No.: 16/295,298

(22) Filed: Mar. 7, 2019

Related U.S. Application Data
(60) Provisional application No. 62/614,548, filed on Jan. 8, 2018.

(51) Int. Cl. G06Q 10/10; H04W 4/029; G06Q 10/06; G06Q 40/00

(52) U.S. Cl. CPC G06Q 10/1097; G06Q 10/1091; G06Q 40/125; G06Q 10/0633; H04W 4/029

(57) ABSTRACT

The present invention relates to a system and method of task tracking and location monitoring. In particular, the invention relates to a series of tracking beacons working in combination with a handheld computing device such as a smartphone to track and monitor worker activity. The key functionalities enabled by this application are: worker management; management of client/customer's receipt of services; task assignment; and worker time tracking. The invention utilizes tracking beacons located at the site where services are performed that can automatically interface with a computing device (such as a smart phone) of a worker. Additionally, the application and the server collect data, and work together to enable enhancements to worker time tracking, and allow for various beacon management function as described herein.

### RELATED APPLICATIONS

The present application claims priority to, and incorporates by reference, U.S. Provisional Patent Application No. 62/614,548 filed on Jan. 8, 2018.

### BACKGROUND OF THE INVENTION

### Field of the Invention

The present invention relates to a system and method of task tracking and location monitoring. In particular, the invention relates to a series of tracking beacons working in combination with a handheld computing device such as a smartphone to track and monitor worker activity.

### Background

Tracking the work of workers is a particularly difficult task. This is especially the case when the workers are working remotely, away from the normal work site, or the work site is not defined by any particular geographic boundary. The problem is made worse when the nature of the tasks performed are especially important, such as in the case of health care related tasks.

In situations like nursing care, provided in home, the care givers perform tasks that range from trivial to life saving, often on a routine basis, and without any direct supervision. If a care giving worker is not on site when they need to be, or is late, or for other reasons cannot complete a task the impact can be life threatening.

For example, if a person receiving in home care needs medication administered, needs a prescription filled, or needs assistance with breathing apparatus the worker needs to be present or the health and life of the patient may be put in jeopardy.

It is also important that the caregiver has the most up to date information on the tasks that need to be performed, is in communication with heath care professionals, and with the family of the patient.

Communication between the caregiver and the employer is also critical. It is not enough to merely rely on the caregiver's dependability, or on communication devices like phones.

Other examples of information that is helpful for an employer to gather is the time it takes to complete a task, when a task is complete, if the caregiver is actually at the location they think they need to be, and the like. Reliable communication is also important for these tasks, as well as there is a need to eliminate the time consuming information gathering and feedback associated with prior art methods of performance tracking.

Thus, a need exists for a communication and tracking system that substantially eliminates the problems in the art.

### DETAILED DESCRIPTION OF THE INVENTION

The present invention is comprised of various hardware and software application solutions, which solve the technological problem of tracking the performance of tasks by workers during their employment and particularly when the workers are working remotely, and more particular when they are providing tasks critical to a person's safety, health, and wellbeing.

The key functionalities enabled by this application are: worker management; management of client/customer's receipt of services; task assignment; and worker time tracking. The invention utilizes tracking beacons located at the site where services are performed that can automatically interface with a computing device (such as a smart phone) of a worker. Additionally, the application and the server collect data, and work together to enable enhancements to worker time tracking, and allow for various beacon management function as described herein.

The server portion of the application is preferably programmed using Microsoft's .NET framework which is a combination of the MVC web framework (or model-view-controller that separates the data model with business rules from the user interface), Web API (a framework for building HTTP based services that can be accessed in different applications on different platforms such as web, windows, mobile etc), and the mobile portion is an Android based OS for smart phones; however, the invention is not so limited and it is contemplated that many other platforms can and will be used.

The server hosting the web application includes the following integrations or dependencies between services and software components:

### .NET Web API Application

The .NET Web API Application consists of 4 main project components: GoldenHome.Web—Responsible for housing the MVC and API applications, also serves as the rough controlling logic for the entire application; GoldenHome.Data—Responsible for all entities that exist on the Microsoft SQL Server database and the connection to that database; GoldenHome.Core—Contains helper functionality for the rest of the application (enumerables, extensions, and helpers); GoldenHome.PayPeriodCreator—Small console application for generating pay periods on a schedule; Additionally, GoldenHome.DataMigration existed to migrate data from an old database to a new one.

### Microsoft SQL Server

This houses all of the data/information within the project. It includes users, workers, clients, service levels, service tracking, time tracking. UML diagram found separately.

### Google

Gmail email server for sending out emails

### Twilio

Service for text messaging

### Docusign

Used for online signature request forms

Information is primarily captured through the web interface, with workers, clients, and services managed through that platform.

Another component of the present invention comprises the tracking beacon technology, and associated application. The beacons comprise low energy radio broadcasting devices, communicating for example using the Bluetooth protocol, that are placed in various locations. The beacon's signals can be picked up by an application, for example running on a smartphone, thereby allowing a worker's device to automatically locate, track, and log events based on proximity to the beacons. The beacon application itself consists of 2 major components: Beacon

The present invention uses a commercially available beacon from kontakt.io (but the invention is not so limited).

### Android Application

The main application which performs the user-side business logic. It connects with the .NET Web API Application.

The initial application setup involves the following sequence flow: Worker downloads the Android Application to a personal computing device such as a smart phone; When the worker logs in to the application on their phone, the application sends a request to the Web Application API that enables a phone-to-worker customer request to be generated, this information is stored in the server database; The worker's manager is able to log into the web application and associate the phone request (e.g. ABCD) with a worker—and then with client based tasks assigned to that worker; After this point, every time the particular worker launches their phone, the application on the worker's phone lists any clients the worker is associated with and the assigned tasks, this association is done through the web platform.

Once the application has been associated with a worker, when they login they will be presented with the clients that they are assigned to. After the setup, when the worker checks in at a client site to perform tasks, the following process occurs:

The Android Application begins scanning for beacons via Bluetooth.

If it locates the correct site beacon, it catalogues that beacon ID and Timestamp locally on the Android device.

Once the Android application has an Internet/network/cellular or appropriate network connection to the main application (whether cellular or wireless) it performs a batch request to the server, which creates TimesheetLogEntries associated with each beacon check-in.

The server receives these check-ins as a collection, and resolves three types of requests: Check-In; Beacon Found; and Check-Out.

Once the session has been completed (check-out has occurred), the application returns to a state where the user can check-in at another site/task. No scanning occurs during this state.

Additional, database segments are contemplated. The database through the interface between the Android application and server application tracks and process: worker payments (which may be time or task based); worker pay periods; worker signatures can be obtained through the Android application for task completion, time sheets, and the like; time entry; time sheet events; worker information (such as name, address, status, position, and the like); client information (such as location, tasks to be performed, and the like); beacon information such as location; client task assignments; services agreements; and the type of services that can be assigned to clients/workers.

The flow of the invention is described in more detail as follows. A system administrator having access to system settings in the server application will be able to set up a worker in the application, by entering the worker's basic information such as name, title, social security information, and the like. The worker will then be able to load the Android application on their smart phone, and create a password and username to allow them to access the account. That information may be accessible to the employer. In any event, the worker will give (or the device transmit) to the employer the smart phone telephone number, device ID, and other contact information such as an email address to allow for communication therebetween.

The employer can then assign tasks to the employer through the server application. The tasks will have associated with them a location, work details, times, and other information that might be useful to the worker. In this manner, a schedule for the worker can be created, and made available to the worker through the Android application on the worker's smartphone. The worker can then travel to the various sites and perform the tasks. Any beacons at the site can track the worker's time at the site, as confirmed by the worker's use of the check-in and check-out function running on the smart phone application, and the application can automatically check the worker in and out of the site through the onsite beacons.

In particular, if a worker is traveling to a site to perform an assigned task, the application can track the worker's location and alert the supervisor of the worker's proximity thereto. If a beacon is at the site the application may automatically log in the worker (this capability is configurable) sending an alert to the supervisor. Alerts can also be sent if the worker is late by varying amounts of time. If there is no beacon, or the beacon is not working, the worker can manually check in at a site, with an alert sent to the supervisor (or logged for later communication if there is not remote communication capability). Additionally, if a first worker cannot make it, or must leave before the task is completed, a second worker can be assigned the task and repeat the process.

Once a worker is checked in at a site, and is working on a task, the worker would remain engaged until they either complete the task, check out to run an errand, or in the case of an emergency (for example) cancel or end the task with a notification to the supervisor.

Upon completion of a task, the worker marks the task done on the smart phone and a notice is sent to the employer. Beacon data, if available, provides verification. The next task can then begin, or the worker can check out from the application if no further tasks remain.

The smart phone application communicates the worker's status to the server application, in real time or later if an internet/cellular connection is not available, so the employer can track status and monitor if any task have been missed.

The application allows for the creation of timesheets that can be used to generate paychecks, or otherwise track and report on worker accomplishments.

When tasks are assigned to the worker additional information about the tasks can be viewed by the worker on the smart phone, such as the location, time for the tasks, anticipated time for completing the tasks, any special instructions relating thereto, and the like. Once the task is completed the worker can fill out the information on the smart phone and the server is updated as soon as a connection is available between the server and the phone.

At any time a task can be interrupted or suspended, for example if the worker needs to run an errand. The smart phone application includes a run errand function, which when selected suspends the task, checks the worker out (unless the beacon does so already), and waits for the worker to return to resume the task. Further, notes relating to the task can be entered into the application by the worker.

With regard to tasks the employer and/or the worker may exercise the following options (either from the application or the server): view details of the task; check in; check out; log an errand event; cancel an appointment/task; delete an appointment/task; or restore an appointment/task. The permissions can be set with regard to the foregoing by the system administrator.

The application also includes a section for various settings, such as: setting notifications settings (alarms, tones, text, email); and profile information (name, address, email, phone number).

The present invention can be similarly used to create documents associated with billing and insurance reimbursement as related to the tasks performed by the workers. For example, if the task are reimbursable the information in the system can be used to automatically generate the appropriate forms needed to receive reimbursement. In particular, insurance provider information will be stored as configuration data in the application, and retrieved when needed in the creation of claim documents. Typically, only a single insurance provider will be available through this configuration, however, it is possible that claims for reimbursement can be submitted to multiple insurance providers.

Claims documents and forms are then generated by the application and from payroll records, and can be verified/singed through an secure third party provider such as DocuSign, and its API.

A claims document generator application represents the processes involved in generating a claims document through the application. A claim collector application is an underlying service that is responsible for the generation of claims documents and processing. It performs the following tasks: collects claims from a signed (via DocuSign) pay period's timesheet entries for each patient who received services; generates appropriate billing/reimbursement codes (such as X12 EDI 837P) from these collected claims; and marks a pay period as processed.

A claim controller application serves as the transfer point of commands between the insurance processing web interface, and the claim collector service, as well as other internal services. It's primary purpose is to perform the following functions: display an index view of pay periods that are ready for claims processing, where this view will also allow a pay period to be marked as processed, as well as filter specific claims out of the export document if needed; download claim processing document for a pay period; mark a pay period as processed. The view allows the action, the controller calls the necessary service features to mark the appropriate pay period.

The above specification is for illustrative use only. The scope of the present invention is defined by the following claims. The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1. A task tracking system, comprising;
a plurality of tracking beacons located on a site where tasks are to be performed;
a remote computing device running a software application that tracks task performance, and interfaces with the tracking beacons to record contact between the remote computing device and the beacons; and
a server interfacing with the application on the remote computing device having a database of tasks to be performed, locations where the tasks are to be performed, of workers available to perform the tasks, and remote computing device information for the workers.

2. The invention of claim 1 further comprising an administrator for assigning tasks stored in the database to workers via the workers' remote computing device.

3. The invention of claim 1 where the beacons record the time the remote computing device makes contact with the beacon and the time the remote computing device ends contact with the beacon.

4. The invention of claim 3 where the times are used by the server to determine worker payment for the task.

5. The invention of claim 1 where the remote system sends alerts associated with the tasks.

6. The invention of claim 5 where the alerts comprise one or more of the following alerts: task begun, task completed, task overdue, worker in proximity to task location, or worker has left proximity of task location.

7. The invention of claim 1 where the system verifies using the remote computing device and worker information that the worker assigned to a task is at the location of the task.

8. The invention of claim 1 where the worker uses the remote computing device to log the status of the task.

9. The invention of claim 8 where the status comprises one or more of the following: task begun, task completed, task interrupted, task cancelled, task deleted, or task restored.

10. The invention of claim 1 where the system calculates billing and reimbursement information for the task.
